(19) United States
(12) Patent Application Publication
(10) Pub. No.: US 2015/0286961 A1
(43) Pub. Date: Oct. 8, 2015

(54) METHOD AND SYSTEM FOR PROVIDING REPLACEMENT EVENT TICKETS

(71) Applicant: Christopher HAMICK, Chicago, IL (US)

(72) Inventor: Christopher HAMICK, Chicago, IL (US)

(21) Appl. No.: 14/247,931

(22) Filed: Apr. 8, 2014

(51) Int. Cl. G06Q 10/02; G06Q 20/18

(52) U.S. Cl. CPC G06Q 10/02; G06Q 20/18

(57) ABSTRACT

A system and machine-implemented method for providing a commemorative ticket based on information obtained from an issued event ticket. An existing event ticket may be scanned and configuration options for the commemorative ticket chosen. After payment is received, a commemorative ticket may be produced and delivered to the ticket purchaser or designated recipient.

### BACKGROUND

The present disclosure generally relates to providing a replacement ticket and, in particular, to providing a commemorative ticket based on information from an existing ticket.

A user typically purchases a seating ticket to an event, such as sporting events, concerts, shows and the like. The ticket may be an electronic or digital ticket that is provided to the user electronically and is printed by the user on regular printer paper. The ticket may also be a printed paper ticket that is mailed to the user or left at the box office of the venue for will call pickup. These tickets are typically low quality and may be folded over and put in a pocket or a wallet before the user needs to access them to enter the venue for the event. It is desirable to be able to provide a decorative commemorative ticket for use as a keepsake.

### SUMMARY

The disclosed subject matter relates to a computer implemented method for providing a commemorative ticket. The method includes obtaining, by a ticket input device, event information from an issued event ticket. The method also includes determining, by one or more processors, a composition of a commemorative ticket based on the obtained event information. The method further includes producing, by at least one production device, the commemorative ticket using the determined composition. The method also includes providing the commemorative ticket to a designated user.

The disclosed subject matter further relates to a commemorative ticket system. The system includes a first input device for obtaining event information from an issued event ticket. The system also includes a computer for determining commemorative ticket features to be included with a commemorative ticket. The system further includes a database in communication with the computer, the database comprising user information associated with the issued event ticket. The system also includes a production device in communication with the computer, wherein the production device produces a commemorative ticket based on the event information, the commemorative ticket features and the user information.

The disclosed subject matter also relates to a commemorative ticket system. The system includes a server computer and an input device in communication with the server computer, the input device configured to obtain event information from an issued event ticket. The system also includes a database in communication with the server computer, the database comprising event information associated with an issued event ticket. The system further includes a printer in communication with the server computer, wherein the printer is configured to produce a commemorative ticket based on the event information obtained from the issued event ticket.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several embodiments of the subject technology are set forth in the following figures.

FIG. 1 illustrates an example of a commemorative ticket system.

FIG. 2 illustrates another example of a commemorative ticket system.

FIG. 3 illustrates another example of a commemorative ticket system.

FIG. 4 illustrates an example process for providing a commemorative ticket.

FIG. 5 conceptually illustrates an example system with which some implementations of the subject technology can be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein. In some instances, structures and components are shown in block diagram form in order to avoid obscuring the concepts of the subject technology.

Tickets are typically required for entry into a variety of events, such as sporting events, concerts, theaters, shows and the like. Tickets traditionally have been printed and either mailed to the ticket purchaser or held at the box office of the venue hosting the event for pickup by the purchaser. These tickets may be perforated heavy stock paper that is torn apart at the perforation when the ticket holder enters the event venue, the ticket holder retaining one portion of the torn ticket.

Tickets may also be digital tickets that are purchased online and emailed to the purchaser, who then prints out a copy of the tickets on a printer. These tickets are typically printed on standard printing paper and include a bar code that may be scanned upon entrance to the event venue, thus the complete printed ticket remains in the possession of the ticket holder. However, the quality of these tickets is dependent upon the quality of the printer they are printed on and the quality of the paper stock used for the tickets. Also, such paper printed tickets are typically large (e.g., 8.5×11 inches) and may be folded for carrying in a purse, wallet or pocket prior to entry to the event, thus creating crease marks.

A higher quality commemorative ticket is often desired by a ticket purchaser to keep as a souvenir or keepsake. In some cases, upon purchasing a digital ticket to an event the purchaser is given an option to order a commemorative paper ticket at the same time. The digital ticket is be emailed to the purchaser, while the commemorative ticket is mailed to the purchaser. The commemorative ticket may have a fake bar code that does not allow it to be used for entry into the event. Alternatively, the commemorative ticket may have a usable bar code that allows the commemorative ticket to be used for entry into the event.

As noted above, commemorative tickets typically are ordered at the time of purchase of the original ticket, with the original ticket being either a digital ticket or a paper ticket. However, the ticket holder may not elect to purchase a commemorative ticket at the time the event ticket is purchased, but the ticket holder may desire to obtain a commemorative ticket once the ticket holder is caught up in the excitement of the event or finds out that other people the ticket holder knows have obtained commemorative tickets. It is desired to provide a system and method for providing a commemorative ticket using some or all of the event information on an issued event ticket, where the commemorative ticket may be ordered and provided during or after the event.

The subject technology provides for a system that uses an input device (e.g., bar code scanner, QR code scanner) to input event information from an issued event ticket. The event information may include the date, the seat location, the venue, the event (e.g., name of band, show, play, sporting event and the like), etc. For example, both originally printed tickets and digital tickets printed on paper described above may have graphics depicting the venue and/or the event, as well as seat location and the date of the event. An issued ticket may also include personal information related to the ticket holder, such as the ticket holder's name. The information input to the input device may include some or all of this information, which then may be used to create a commemorative ticket.

Alternatively, the information obtained from the issued ticket may identify the ticket, and additional information related to the issued ticket may be accessed in a database in order to create a commemorative ticket. For example, the issued ticket may list the seat location, event to be attended, and the date of the event, but not any user information. Scanning the issued ticket then provides identifying information for that issued ticket that may then be matched with the ticket purchaser's user information from the purchase of the issued ticket, such as the ticket purchaser's name, address and the like. For example, the event information (e.g., seat location, event name, date) may be obtained directly from scanning the issued event ticket and then the event information may be associated or cross-referenced with user information in a database that is associated with either the ticket purchaser or a user designated by the ticket purchaser.

The input device may be part of a complete standalone system such as a kiosk. For example, an event venue such as a stadium may have multiple kiosks located throughout the stadium. The kiosk may include a ticket scanner for obtaining issued ticket information, a credit card reader for payment, a computer for processing the order and providing a commemorative ticket, and a printer for printing the commemorative ticket. Such a kiosk may be a standalone kiosk where the order is placed, the issued ticket scanned and the commemorative ticket is printed on the spot. On the other hand, a kiosk may be used for input purposes only, such as entering the order, scanning the issued ticket and accepting payment, but the production of the commemorative ticket is performed elsewhere.

For example, the commemorative ticket may be produced (e.g., printed) at a central printing site in the stadium and made available for pickup by the commemorative ticket purchaser at the central site. As another example, the commemorative ticket may be printed at an offsite production facility and mailed or delivered to an address designated by the ticket purchaser.

In example aspects, a portion of the commemorative ticket system may be portable or handheld. For example, a ticket scanner and a credit card reader may be provided as a portable system or device that is carried by vendors or ushers at the event venue, or included on a vendor cart that is moved about within the venue. The ticket scanner and credit card reader may be wirelessly connected to one or more servers, computers or intelligent printers. Here, the vendor may scan in the issued ticket and swipe the ticket holder's credit card for payment, upon which the event information obtained from the issued ticket is sent to a server that sets up and produces a commemorative ticket on a printer, which can then be made available for pickup at the venue or mailed to the ticket holder. The mailing address may be the ticket holder's shipping address associated with the ticket holder's credit card, or the address may be designated by the ticket holder at the time of purchasing the commemorative ticket.

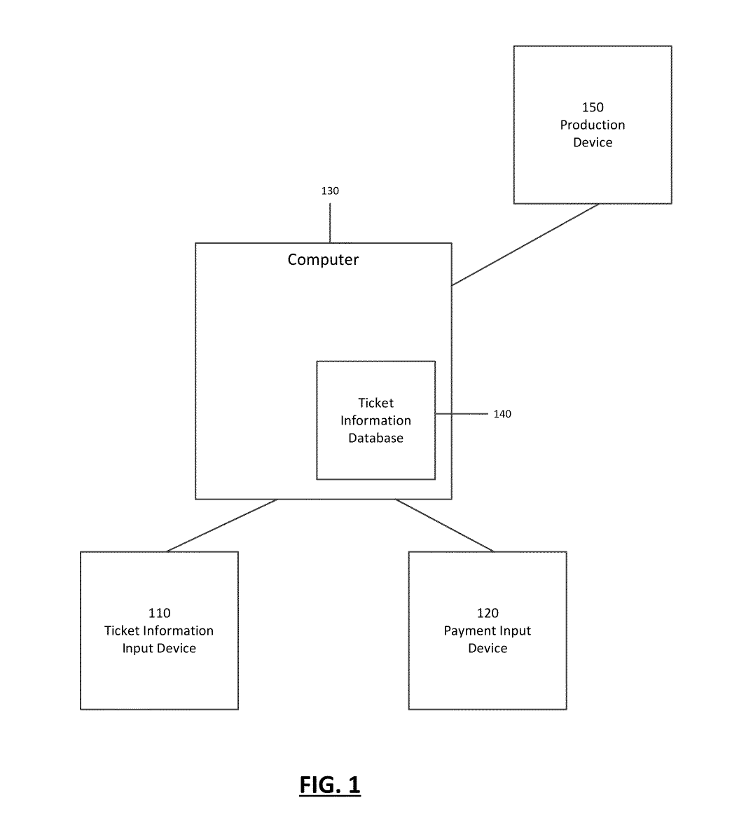

FIG. 1 illustrates an example of a commemorative ticket system 100 having a ticket information input device 110, a payment input device 120, a computer 130, a database 140 and a production device 150. Ticket information input device 110 may be a bar code scanner, a QR code scanner, a camera and the like. Alternately, ticket information maybe input via a keyboard or other manual input device, and/or may be linked with an event. Payment input device 120 may be a card reader adapted to read debit cards, credit cards, membership cards, gift cards and the like. Computer 130 may be any of a desktop computer, a laptop computer, an embedded computer, a tablet computer, a smartphone and the like. Database 140 may include any of event information, seat information, ticket purchaser information (e.g., credit card information, shipping address) and the like. Production device 150 may be any device adapted to produce or further process a commemorative ticket, such as a printer, a laminating device, an embossing device, and the like.

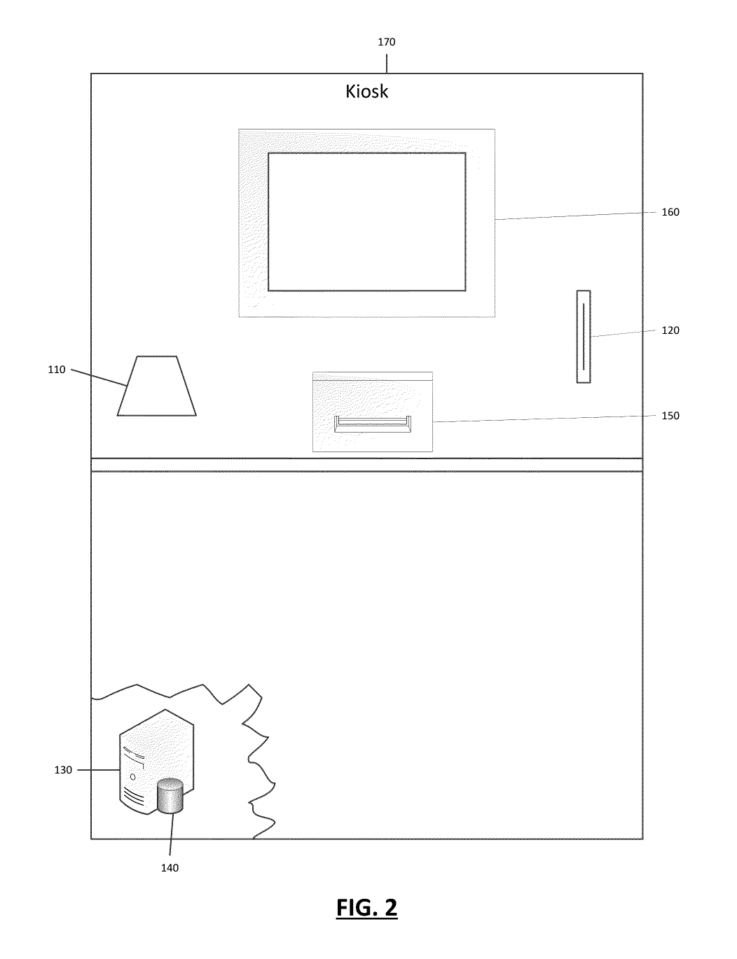

Commemorative ticket system 200 illustrated in FIG. 2 is shown as a local system, such as a kiosk system having a kiosk housing 170, a scanner as the ticket information input device 110, a credit card reader as the payment input device 120, a desktop computer as the computer 130 having a ticket information database as the database 140, and a color printer as the production device 150. The commemorative ticket system 200 further includes a touchscreen display as a user interface 160, though other user interfaces 160 may be used, such as keyboards or keypads in combination with a display, for example. The user interface maybe utilized to input event information. While commemorative ticket system 200 is shown as a kiosk system, the subject technology may also be configured as a cart based system, a counter top system in a store, and the like.

As a local system, commemorative ticket system 200 provides for a ticket holder to scan a previously printed issued event ticket on the scanner 110, swipe a credit card through the credit card reader 120 for payment and have a commemorative ticket printed on the spot by the color printer 150 for immediate pick up. The commemorative ticket system 200 may also provide a user interface through the touchscreen display 160, thereby allowing the ticket holder to choose additional options for the commemorative ticket, such as gold leaf highlights or higher quality base stock (e.g., heavier card stock), for example. Additionally, the display 160 may allow the user to enter event information via the user interface and/or select graphics for the commemorative ticket via the user interface. Alternatively, the ticket holder may choose to order the commemorative ticket at the kiosk and have the commemorative ticket delivered to a designated address (e.g., mailed, shipped or delivered by courier), in which case the commemorative ticket may be produced on one or more production devices 150 located in another location, such as a printing plant or production facility, for example.

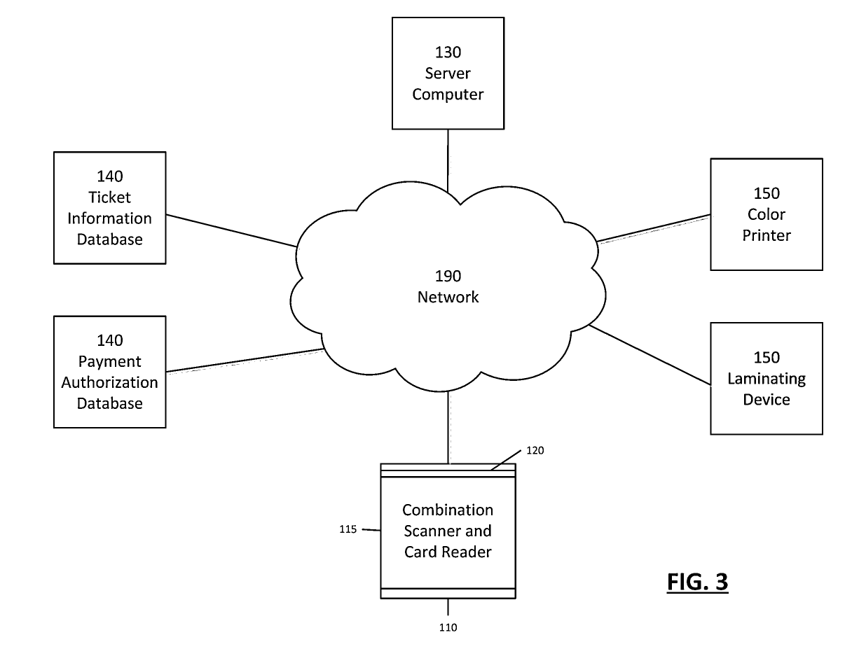

In another embodiment, a commemorative ticket system 300 illustrated in FIG. 3 is shown as a distributed or networked system that is interconnected through a network 190. The commemorative ticket system 300 includes a handheld input device 115 that combines a scanner as the ticket information input device 110 and a card reader as the payment input device 120. The commemorative ticket system 300 also includes a server computer as the computer 130 and both a ticket information database and a payment authorization database as multiple databases 140. The commemorative ticket system 300 further includes both a color printer and a laminating device as multiple production devices 150.

While each component of commemorative ticket system 300 is shown as being connected to or through the network 190, any combination of the commemorative ticket system 300 components may be connected together or integrated together. For example, the databases 140 may reside on the server computer 130 and/or the production devices 150 may be directly connected to the server computer 130. Further, any connections between components or between a component and the network 190 may be wireless or directly cabled.

As a networked or distributed system, commemorative ticket system 300 allows for different parts of the process to be provided at different locations and/or at different times. For example, a vendor may walk up and down the steps of a stadium selling commemorative tickets to the attendees at the event occurring in the stadium. The vendor may scan a ticket holder's issued ticket and swipe the ticket holder's credit card using one or more handheld devices. The vendor may also print a receipt and select whether the ticket holder will pick up the commemorative ticket at a pickup window in the stadium or if the commemorative ticket is to be mailed to the ticket holder's credit card mailing address.

For example, the commemorative ticket may be printed at a centralized site in the stadium or it may be printed at a production facility offsite. A centralized production facility may allow for more production devices 150 in order to provide more commemorative ticket options. For example, a commemorative ticket may be printed on high quality raised lettered or embossed card stock with gold leaf highlights added, a protective lamination added, and a laser etched hologram added, which may require multiple production devices 150 or one or more comprehensive industrial production devices that combine many or all of these production processes.

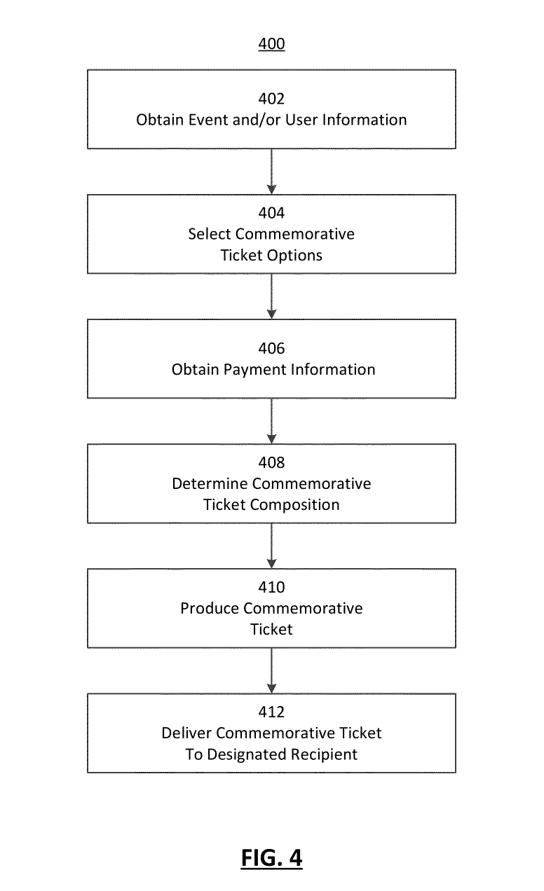

FIG. 4 illustrates an example process 400 which produces a commemorative ticket based on an issued event ticket. The process 400 begins at step 402 where event information and/or user information from an issued event ticket is input or obtained. This may be accomplished by scanning the issued event ticket, sending in a photograph or scan of the entire ticket, or directly keying in the information. For example, a bar code or QR code on the issued ticket may be scanned to provide information regarding the event as well as information specific to that ticket, such as the seat location and the ticket holder's name. As another example, user information (e.g., address) may be input or obtained from a database or other source having user information that is associated with issued event ticket. One source may be the holder of the credit card used to purchase the commemorative ticket. Commemorative ticket options may be selected at step 404. Continuing the example, the ticket holder may choose various options from a user interface (e.g., a touch screen), such as selecting the specific graphics, adding gold leaf, adding a lamination and the like. Alternatively, the commemorative ticket process may not offer any options to the ticket holder, in which case step 404 may be skipped.

At step 406, payment information is obtained, such as by swiping a card (e.g., debit/credit card) through a card reader to obtain payment. For example, a credit card is swiped, an authorization request is sent to the credit card issuer, and a payment authorization is received from the credit card issuer showing payment from the commemorative ticket purchaser to the commemorative ticket seller or vendor. A composition of the commemorative ticket to be produced is determined at step 408. For example, a commemorative ticket design may have a default composition, such as color printing on a specific quality of card stock. This default composition may be the only available option, in which case the composition determining step 408 may be skipped. On the other hand, the default composition may be altered or added to by selection of additional options, such as graphics, adding gold leaf, higher quality card stock, lamination and the like.

At step 410, a commemorative ticket is produced by at least one production device or process. For example, a commemorative ticket may be produced by using a single printer to print a commemorative ticket on a selected grade of laminated card stock having gold leaf highlights. As another example, the same commemorative ticket may be produced by printing a ticket on base card stock, adding the gold leaf highlights in another production device, and laminating the resulting ticket in yet another production device.

The process 400 ends at step 412 where the commemorative ticket is provided to the commemorative ticket purchaser or to a designated address. For example, the commemorative ticket may be provided directly to the commemorative ticket purchaser at the site the purchase was made (e.g., at a kiosk, at a store, delivered to the ticket holder's seat). On the other hand, the commemorative ticket may be provided for pick up at a central site (e.g., will call window, VIP lounge). In yet another example, the commemorative ticket may be delivered (e.g., mailed, shipped, couriered) to an address designated by the ticket purchaser (e.g., mailing address associated with credit card, address entered by ticket purchaser). The commemorative ticket may be provided or delivered to the ticket purchaser or to another person designated by the ticket purchaser. For example, the ticket purchaser may wish to provide the commemorative ticket to a family member or friend as a gift.

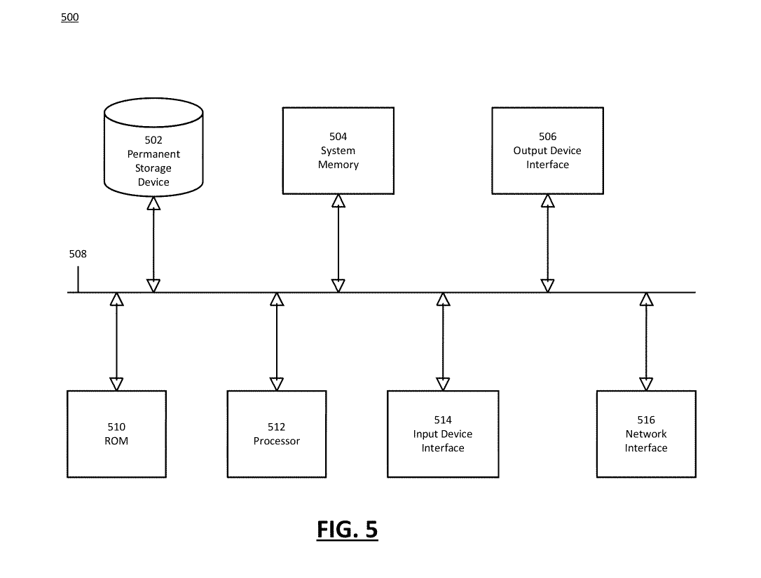

FIG. 5 conceptually illustrates an example electronic system with which some implementations of the subject technology can be implemented. Electronic system 500 can be a computer, phone, PDA, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (for example, a magnetic or optical disk and its corresponding disk drive) as permanent storage device 502.

Other implementations use a removable storage device (for example, a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, or ROM 510. For example, the various memory units include instructions for unlocking an electronic device in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, for example, liquid crystal displays (LCD). Some implementations include devices, for example, a touchscreen that functions as both input and output devices.

Further, as shown in FIG. 5, bus 508 also couples electronic system 500 to a network (not shown) through a network interface 516. In this manner, the computer can be a part of a network of computers (for example, a local area network (“LAN”), a wide area network (“WAN”), or an Intranet, or a network of networks, for example, the Internet. Any or all components of electronic system 500 can be used in conjunction with the subject disclosure.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example, microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example, is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., an LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

What is claimed is:

1. A computer implemented method for providing a commemorative ticket, the method comprising:
obtaining, by a ticket input device, event information from an issued event ticket;
determining, by one or more processors, a composition of a commemorative ticket based on the obtained event information;
producing, by at least one production device, the commemorative ticket using the determined composition; and
providing the commemorative ticket to a designated user.

2. The computer implemented method of claim 1, further comprising:
receiving, by one or more processors, one or more commemorative ticket features selected at a user input device; and
producing the commemorative ticket using the selected commemorative ticket features.

3. The computer implemented method of claim 1, wherein the event information is obtained by scanning the issued event ticket with a scanner at a kiosk.

4. The computer implemented method of claim 1, wherein the event information is obtained by scanning the issued event ticket with a portable scanner.

5. The computer implemented method of claim 1, wherein the production device is a printer at a kiosk.

6. The computer implemented method of claim 1, further comprising:
transmitting the determined composition to the production device at a production site, wherein the production device is a centralized printer.

7. The computer implemented method of claim 1, further comprising:
receiving, by a payment input device, payment for the commemorative ticket.

8. The computer implemented method of claim 7, further comprising:
determining, by one or more processors, that payment has been authorized; and
producing the commemorative ticket based on the payment authorization.

9. The computer implemented method of claim 7, wherein the payment input device is a credit card reader.

10. The computer implemented method of claim 1, wherein the production of the commemorative ticket comprises printing the commemorative ticket and further processing the commemorative ticket to add at least one additional feature.

11. A commemorative ticket system comprising:
a first input device for obtaining event information from an issued event ticket;
a computer for determining commemorative ticket features to be included with a commemorative ticket;
a database in communication with the computer, the database comprising user information associated with the issued event ticket; and
a production device in communication with the computer,
wherein the production device produces a commemorative ticket based on the event information, the commemorative ticket features and the user information.

12. The commemorative ticket system of claim 11, wherein the first input device is a scanner configured to read at least one of a bar code and a QR code.

13. The commemorative ticket system of claim 11, further comprising:
a second input device for inputting a payment; and
a second database in communication with the computer, wherein the second database provides an authorization that payment for the commemorative ticket has been received.

14. The commemorative ticket system of claim 13, wherein the second input device is a credit card reader.

15. The commemorative ticket system of claim 11, wherein at least a portion of the commemorative ticket system is housed in a kiosk.

16. The commemorative ticket system of claim 11, wherein at least a portion of the commemorative ticket system is adapted to be portable.

17. A commemorative ticket system comprising:
a server computer;
an input device in communication with the server computer, the input device configured to obtain event information from an issued event ticket;
a database in communication with the server computer, the database comprising event information associated with issued event ticket; and
a printer in communication with the server computer,
wherein the printer is configured to produce a commemorative ticket based on the event information obtained from the issued event ticket.

18. The commemorative ticket system of claim 17, further comprising:
a credit card reader in communication with the server computer, wherein the input device and the credit card reader are hand-held devices having a wireless communication link to the server computer.

19. The commemorative ticket system of claim 17, wherein the input device is a scanner.

20. The commemorative ticket system of claim 17, further comprising:
a user information database in communication with the server computer, the user information database comprising user information associated with the requested commemorative ticket,
wherein the commemorative ticket system is configured to produce the commemorative ticket based on the event information and the user information.
